(19) United States
(12) Patent Application Publication
(10) Pub. No.: US 2026/0009460 A1
(43) Pub. Date: Jan. 8, 2026

(54) FLAT GEARING

(71) Applicant: Harmonic Drive SE, Limburg an der Lahn (DE)

(72) Inventor: Frank ZENS, Diez (DE)

(73) Assignee: Harmonic Drive SE, Limburg an der Lahn (DE)

(21) Appl. No.: 19/112,620

(22) PCT Filed: Sep. 15, 2023
(86) PCT No.: PCT/EP2023/075395

§ 371 Date: Mar. 18, 2025

(30) Foreign Application Priority Data
Sep. 23, 2022 (DE) 102022124529.2

(51) Int. Cl. F16H 49/00; F16H 55/08

(52) U.S. Cl. CPC F16H 49/001; F16H 55/0833; F16H 55/0886; F16H 2049/003

(57) ABSTRACT

A flat gearing in the form of a strain wave gearing includes a circular spline having an inner toothing; a dynamic spline which is axially adjacent to the circular spline and has an inner toothing; a flexible flexspline which is arranged inside the circular spline and dynamic spline and has at least one outer toothing; and a wave generator which is arranged inside the flexspline for deforming the flexspline in the radial direction. An interlocking, torque-transmitting connection is established between the circular spline and the flexspline at two opposing points on the flexspline and between the flexspline and the dynamic spline at four positions on either side of the contact with the circular spline. The axial course of the radial position of the tooth transverse of the at least one outer toothing of the flexspline has a region which is reduced radially in the direction of a center axis of the flat gearing.

### CROSS-REFERENCE TO RELATED APPLICATIONS

This application is a national stage application (under 35 USC § 371) of PCT/EP2023/075395, filed Sep. 15, 2023, which claims benefit of DE 102022124529.2, filed Sep. 23, 2022, the contents of each of which is incorporated by reference herein.

### BACKGROUND OF THE INVENTION

The invention relates to a flat gearing in the form of a strain wave gearing with a circular spline with an inner toothing, an axially adjacent thereto dynamic spline with an inner toothing and a flexible flexspline arranged within the circular spline and dynamic spline with at least one outer toothing and a wave generator arranged within the flexspline for deforming the flexspline in the radial direction. By deforming the flexspline, an interlocking, torque-transmitting connection is established between the circular spline and flexspline at two opposing points on the flexspline and between the flexspline and dynamic spline at four positions on either side of the contact with the circular spline. Such flat gearings thus comprise four main components, namely the wave generator, the flexspline, the dynamic spline and the circular spline.

When the strain wave gearing is in reduction mode, i.e. when the speed is being reduced, the elliptical wave generator serves as the drive element. The wave generator deforms the flexspline (FS), which is engaged with the internally toothed hollow gears, the circular spline (CS) and the dynamic spline (DS), via a bearing, in particular a thin-section rolling bearing. When the wave generator (WG) turns, the major elliptical axis and thus the tooth engagement region shifts. Since the flexspline has fewer teeth—in particular two fewer teeth—than the circular spline, the flexspline turns relative to the circular spline during a half-turn of the wave generator, in particular by the angle of one tooth pitch, and during a full turn by the angle of two tooth pitches. When the circular spline is stationary, the flexspline rotates in the opposite direction to the wave generator.

The wave generator usually consists of an elliptical steel disk and a thin-section rolling bearing joined to it. This component is used as a drive element in the reduction mode. The circular spline is an internally toothed hollow wheel, the toothing of which engages with the outer toothing of the flexspline in the region of the major elliptical axis of the wave generator. The circular spline usually has two more teeth than the flexspline. The embodiment of the flexspline allows for large elastic deformations in the radial direction. It is brought into an elliptical shape by the wave generator. In the region of the major elliptical axis, the outer toothing of the flexspline engages with the inner toothings of both the circular spline and the dynamic spline.

The dynamic spline is an internally toothed hollow wheel with the same number of teeth as the flexspline. This component rotates in the same direction and at the same speed as the flexspline and is used in reduction mode either as an output element or as a frame. Flat gearings of this kind can be used to advantage in a range of technical fields, particularly in service robotics.

A flat gearing as described above is, for example, described in DE 10 2020 107 674 B3.

A double-shaft gearbox with an externally toothed gear wheel with two outer toothings with different numbers of teeth is known from EP 3 690 280 A1, wherein a gap is formed between these teeth as a cutting gap for a gear cutter.

DE 11 2012 005 159 B4 describes a transmission device of the flexibly interlocking type, which comprises a wave generator and
a tubular external toothed wheel that is flexible and arranged on an outer circumference of the wave generator. It further comprises two internally toothed gears that mesh with the external gear.

A gear reduction mechanism with a flexible external gear is known from JP 2009-133414 A, which is partially in mesh with a rigid internal gear and a sub-rigid internal gear.

The disadvantage of compact flat gearing in the form of strain wave gearing is that the flexspline is used without modifications to the gearing in the flank direction, where increased stresses occur that lead to reduced flat gearing performance.

A flat gearing with optimized load distribution and improved performance continues to be sought.

### SUMMARY OF THE INVENTION

The invention is based on the realization that it is known from the evaluation of practical tests and finite element calculations that in the case of flat gearings, increased stresses occur on the toothed components near the plane between the circular spline and the dynamic spline.

It has now been recognized herein that the increased stresses in the plane between the circular spline and dynamic spline can be reduced by providing the flexspline's toothing in the flank direction with a toothing that is modified (profile-shifted) in certain regions. At low loads, the gearing should bear more heavily in the direction of the front sides of the flexspline. As the load increases, the load-bearing surface increases due to the deformation of the flexspline, and the load is distributed more evenly (than with conventional flat gearing) over the tooth flank.

The radially reduced or, according to the invention, shifted region of the axial course of the radial position of the tooth transverse of the outer toothing of the flexspline can extend axially, starting from the position between the circular spline and dynamic spline, up to the respective front side of the flexspline. It is preferably at its greatest in the plane between the circular spline and dynamic spline or in a region around this plane, and decreases in the direction of the front sides. The shift in the course refers to the radial shift of the front section of the flexspline toothing in the direction of the center axis of the transmission, which results in a reduced expansion of the outer toothing when viewed radially.

The greatest radial shift of the radially reduced region in the direction of the center axis is advantageously located in the region of a plane between the circular spline and dynamic spline. In this way, the increased load on the tooth flank of the flexspline near the plane between the circular spline and dynamic spline, caused by the deformation under load, can be compensated.

The outer toothing is thus axially receded, starting from the plane between the circular spline and dynamic spline, radially in the direction of the transmission axis. The axial course of the radial position of the tooth transverse of the outer toothing of the flexspline thus exhibits a radially reduced (receded) region in the axial direction.

The radially reduced region can be designed symmetrically or asymmetrically with respect to the axial center of the outer toothing. The two hollow wheels (circular spline and dynamic spline) are preferably designed with the same width.

In the case that circular spline and dynamic spline do not have the same axial expansion, the radially reduced region is asymmetrical to the center of the outer toothing of the flexspline. It can be advantageous to design the hollow wheels with different widths due to geometric constraints or different loads on the hollow wheels. Hollow wheels with different widths require an asymmetrical embodiment. Furthermore, depending on the specific meshing conditions, an asymmetrical embodiment may also be more optimal for certain designs of hollow wheels of equal width. The shift in the radially reduced region of the gearing improves the load at the edge and improves the load distribution on the gear wheels.

The radial shift of the front section of the flexspline's outer toothing in the direction of the center axis advantageously decreases linearly in the axial direction from the region with the greatest radial reduction on both sides in the direction of the front sides, i.e. the radial expansion of the outer toothing increases in the direction of the front sides.

Advantageously, the axial course of the radial shift of the front section of the outer toothing of the flexspline in the region of one or both front surfaces assumes a constant value.

The axial course of the radial shift of the front section of the outer toothing of the flexspline advantageously has a convex or concave shape in the radially reduced region (seen in the axial direction). A convex axial course makes it possible to further reduce local high contact stresses.

The front section of the outer toothing of the flexspline is preferably shifted in the region of one or both front sides in the direction of the center axis.

In a preferred embodiment, the flexspline comprises two outer toothings that are separated from one another by a groove, or the two outer toothings may be separated from one another completely.

A value between 0 and 0.2 is selected for the maximum shift of the axial course of the radial position of the tooth transverse of the outer toothing of the flexspline in the direction of the center axis, based on the ratio of the pitch circle to the number of teeth of the flexspline (module). The maximum shift is the difference between the maximum and minimum radial position of a front section of the flexspline toothing (profile shift).

The front section of the flexspline outer toothing in the region of one or both front sides can be preferentially shifted in the direction of the center axis. This shift of the gearing on the front sides can reduce increased contact stresses due to edge loading.

A rolling bearing with rolling elements of the flat gearing comprises preferably balls, rollers or needles as rolling elements.

The advantages of the invention lie in particular in the fact that the shift in the axial course of the radial position of the tooth transverse of the outer toothing of the flexspline takes account of the typical load on the toothing in a flat gearing, as a result of which the load capacity and the service life of the transmission, in particular, are increased by at least 25%.

### DESCRIPTION OF THE DRAWINGS

Each exemplary embodiment of the invention is explained in greater detail based on a drawing. All the features described and/or illustrated form the subject of the present invention, either individually or in any meaningful combination, even independently of their summary in the claims or their relationship to one another. The drawings herein show highly schematized representations as follows:

FIG. 1 a front view of the flat gearing in a preferred embodiment,

FIG. 2 the cross-section of the flat gearing according to FIG. 1 in a side view,

FIG. 3 the cross-section of a variant of the flat gearing with a WG bearing according to FIG. 1 in a side view,

FIG. 4 the cross-section of a variant of the flat gearing with hollow gears of different widths (circular spline and dynamic spline) according to FIG. 1 in a side view,

FIG. 5 an axial course of the radial position of the tooth transverse of the outer toothing of the flexspline of a flexspline toothing in a first preferred embodiment,

FIG. 6 an axial course of the radial position of the tooth transverse of the outer toothing of the flexspline of a flexspline toothing in a second preferred embodiment,

FIG. 7 an axial course of the radial position of the tooth transverse of the outer toothing of the flexspline of a flexspline toothing in a third preferred embodiment,

FIG. 8 an axial course of the radial position of the tooth transverse of the outer toothing of the flexspline of a flexspline toothing in a fourth preferred embodiment,

FIG. 9 an axial course of the radial position of the tooth transverse of the outer toothing of the flexspline of a flexspline toothing in a fifth preferred embodiment,

FIG. 10 an axial course of the radial position of the tooth transverse of the outer toothing of the flexspline of a flexspline toothing in a sixth preferred embodiment,

FIG. 11 an axial course of the radial position of the tooth transverse of the outer toothing of the flexspline of a flexspline toothing in a seventh preferred embodiment,

FIG. 12 a further preferred flat gearing in a side view, and

FIG. 13 a further preferred flat gearing in a side view.

In all figures, the same parts are labeled with the same reference symbols.

### DETAILED DESCRIPTION

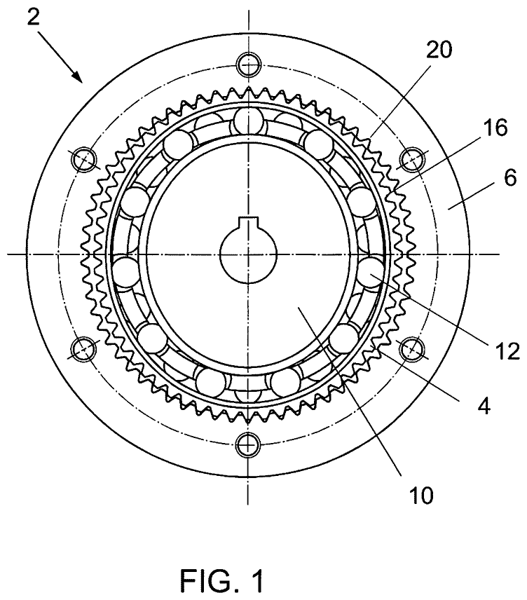

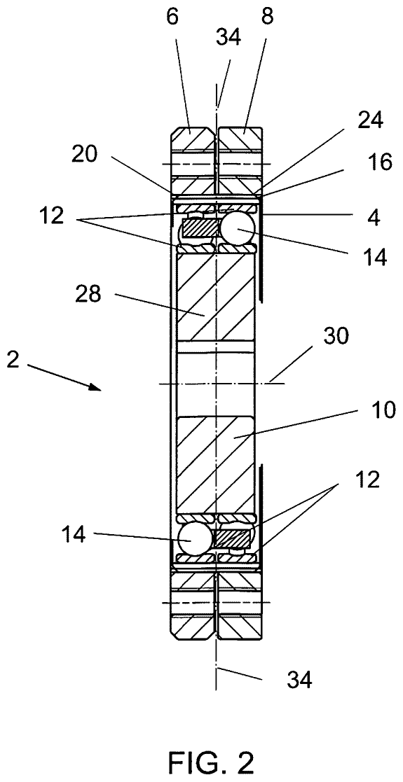

A flat gearing 2, shown in FIG. 1 and FIG. 2, is designed as a strain wave gearing and comprises a flexspline 4, a circular spline 6 arranged coaxially thereto, a dynamic spline 8 and a wave generator 10. The circular spline 6 and the dynamic spline 8 are designed as internally toothed, cylindrical hollow wheels. The flexspline 4 has the shape of a thin-walled hollow cylinder with outer toothing 16. Inside the flexspline 4 is a wave generator 10, formed by a disk 28 arranged in the center, the so-called plug, the outer cross-section of which has an elliptical shape, and two rolling bearings 12 mounted on the outer surface of the plug 28. The cylindrical, thin-walled rings of the rolling bearings 12 and the flexspline 4 are elastically deformed by the plug into an elliptical cross-section. As a result of the deformation, the outer toothing 16 of the flexspline 4 engages in two regions on both sides of the major elliptical axis with the inner toothings 20 and 24 of the circular spline 6 and the dynamic spline 8.

In the exemplary embodiment shown here, the outer toothing 16 of the flexspline 4 has two teeth less than the inner toothing 20 of the circular spline 6 and the same number of teeth as the inner toothing 24 of the dynamic spline 8. When the plug 28 rotates around the transmission axis, the tooth engagement regions of the large ellipses shift following the large ellipse axis in the circumferential direction. Due to the different number of teeth of the flexspline 4 and the circular spline 6, the components rotate relative to each other by an angle of two tooth pitches when the plug 28 rotates once. Since the dynamic spline 8 assumes the same angular position as the flexspline 4 due to the identical number of teeth, the circular spline 6 and dynamic spline 8 rotate relative to each other. If you use plug 28 as the drive element and circular spline 6 and dynamic spline 8 each as the output or frame, you get a transmission with a high gear reduction in a single stage.

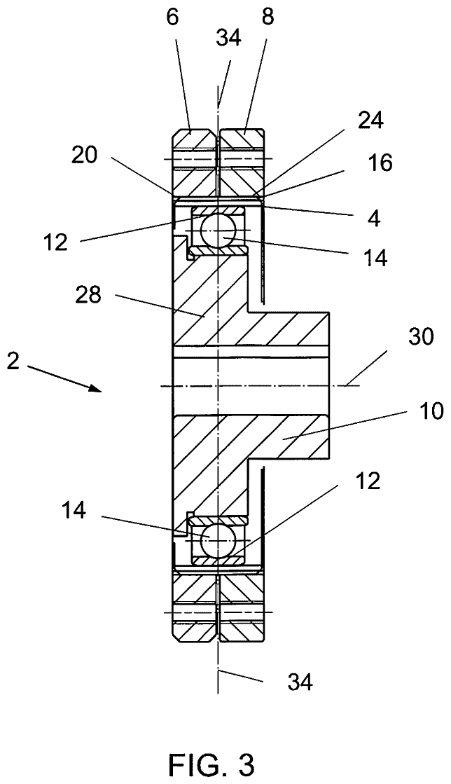

FIG. 3 shows an alternative and preferred flat gearing 2 with only one rolling bearing 12. In the variant with one rolling bearing, this rolling bearing fulfills the same function as the two rolling bearings 12 and 14 in FIG. 1 and FIG. 2. The rolling bearing 12 comprises a row of rolling elements 14, which in this case are designed as balls. Transmissions with only one rolling bearing can withstand lower loads, but are less expensive.

The two hollow wheels (circular spline and dynamic spline or “CS” and “DS”) are preferably designed with the same width. It can be advantageous to design the hollow wheels with different widths due to geometric constraints or different loads on the hollow wheels.

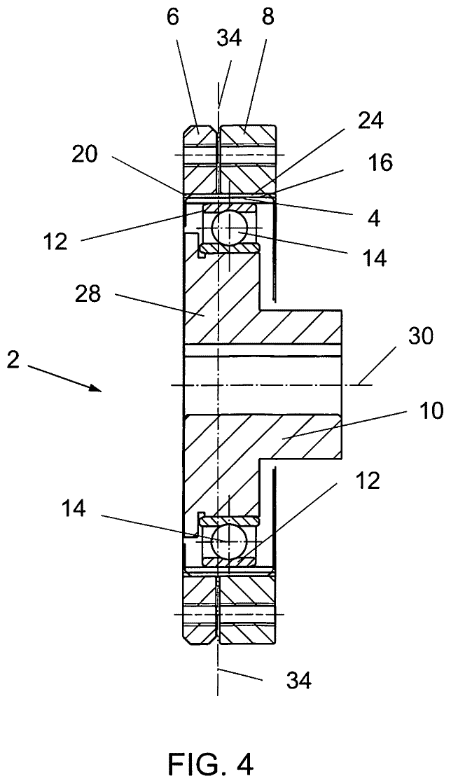

In the side views (cross sections) according to FIGS. 2, 3 and 4, for known flat gearings, 4 each front section of a tooth of the outer toothing 16 of the flexspline 4 is in the same radial position with respect to the transmission axis or center axis 30. The profile shift of the toothing of the flexspline has the same value over the entire width.

In the vicinity of the plane 34 between the circular spline 6 and the dynamic spline 8, the load on the toothing or the outer toothing 16 is greater than in the neighboring lateral regions. This results in excessive wear or damage to the toothing of the flexspline, reducing the performance and load capacity of the flat gearing. To counteract this effect, the present invention proposes to axially withdraw the outer toothing 16 starting from the plane between the circular spline and dynamic spline 34 radially in the direction of the transmission axis.

A reduced axial course in the radial direction 40 of the radial position of the tooth transverse of the outer toothing 16 of the flexspline 4 distributes the load better over the tooth flanks. The stress peak near the plane 34 between the circular spline and dynamic spline, i.e. at the edges of the CS and DS gearing directly at this plane 34, is reduced and thus the performance of the flat gearing is improved.

The following figures show advantageous embodiments for the axial course 40 of the radial position of the tooth transverse of the outer toothing 16 of the flexspline 4.

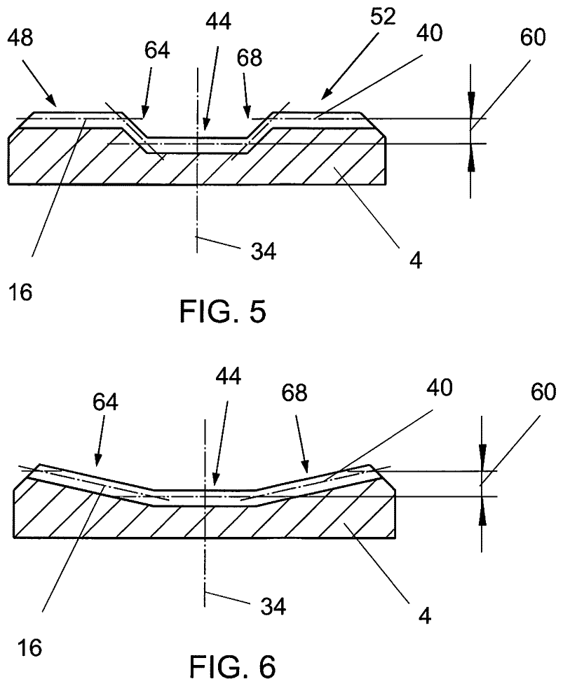

FIG. 5 shows the axial course 40 of the radial position of the tooth transverse of the outer toothing 16 of the flexspline 4 in a first preferred embodiment.

A shift in the axial course of the radial position of the tooth transverse of the outer toothing of the flexspline characterizes the radial shift of the tooth transverse of the outer toothing 16 in the direction of the center axis 30 of the flat gearing 2, starting from a radial design position. The front section is formed in a known manner by the cutting curve between the gearing and any plane parallel to the front surface. If the radial position of the cutting curve is shown as a function of the axial position of the cutting plane, a curve is obtained.

The axial course 40 of the radial position of the tooth transverse of the outer toothing 16 of the flexspline 4 (radial shift of the tooth transverse) of the outer toothing 16 is designed to be symmetrical to the plane 34 between the circular spline 6 and the dynamic spline 8. The shift of the axial course 40 of the radial position of the tooth transverse of the outer toothing 16 of the flexspline 4 radially in the direction of the center axis 30 has the greatest value in the radially reduced region 44 (i.e. a region radially shifted in the direction of the center axis 30) symmetrically to the plane between the circular spline and dynamic spline 34. Subsequently, the axial course 40 of the radial position of the tooth transverse of the outer toothing 14 of the flexspline 6 increases radially in the sections or regions 64 and 68 on both sides, linearly and symmetrically to the plane 34 between the circular spline and dynamic spline up to the design transverse section of the outer toothing 16.

In the further course in sections 48 and 52, the tooth transverse of the outer toothing 16 remains radially with unchanged profile shift on the embodiment position. A distance 60 is the largest amount of the radial shift of the tooth transverse of the outer toothing 16 of the flexspline 4.

FIG. 6 shows a second preferred embodiment of the axial course 40 of the radial position of the tooth transverse of the outer toothing 16 of the flexspline 4. In this second embodiment, the radially reduced region 44, which is located in the region of plane 34 between the circular spline 6 and the dynamic spline 8 and in which the axial course 40 of the radial position of the tooth transverse of the outer toothing 16 of the flexspline 4 has the smallest radial amount, is adjoined on both sides two regions 64, 68 in which the axial course 40 of the radial position of the tooth transverse of the outer toothing 16 of the flexspline 4 linearly increases radially up to the design transverse section at the front sides of the flexspline 6. The preferred embodiment depends on other characteristics of the flexspline 64, such as the number of teeth, the profile shape of the gearing and the wall thickness, and must be determined for the specific example on the basis of the load on the tooth flank.

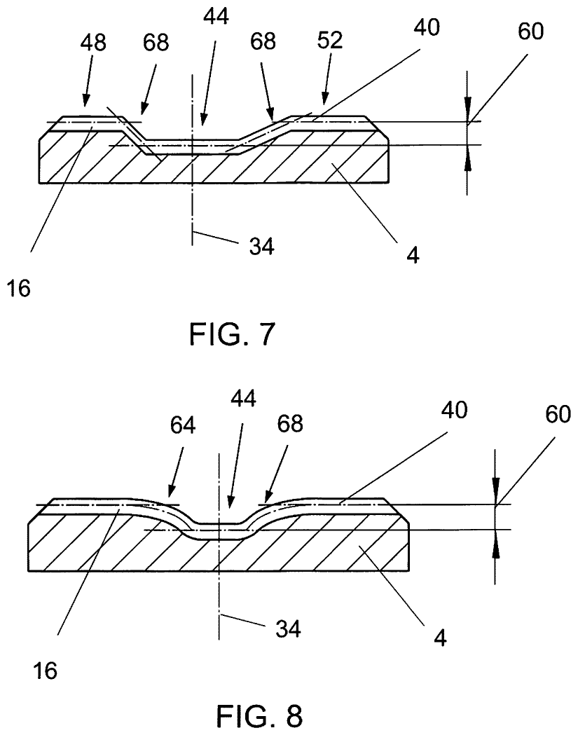

A third preferred embodiment of an axial course 40 of the radial position of the tooth transverse of the outer toothing 16 of the flexspline 4 is shown in FIG. 7. The structure is similar to the course shown in FIG. 5. In contrast to FIG. 5, this embodiment has an asymmetrical position of the plane 34 between the circular spline 6 and dynamic spline 8 and an asymmetrical course of the axial course 40 of the radial position of the tooth transverse of the outer toothing 16 of the flexspline 4.

In this third embodiment, the section of the radially reduced region 44, which is located in the region of plane 34 between the circular spline 6 and the dynamic spline 8 and in which the axial course 40 of the radial position of the tooth transverse of the outer toothing 16 of the flexspline 4 has the smallest amount in the radial direction, is adjoined on both sides of two regions 64, 68 in which the axial course 40 of the radial position of the tooth transverse of the outer toothing 16 of the flexspline 4 increases radially. In the region 64, the course 40 has a greater slope than in the region 68, so that it has a greater width corresponding to region 68.

In the regions 48, 62 adjacent to the regions 64, 68, the axial course 40 of the radial position of the tooth transverse of the outer toothing 16 of the flexspline 4 is constant again. Due to different loads, the circular spline 6 and dynamic spline 8 can be designed with different widths. The asymmetrical embodiment takes this possibility into account.

A fourth preferred embodiment of an axial course 40 of the radial position of the tooth transverse of the outer toothing 16 of the flexspline 4 is shown in FIG. 8. In contrast to the embodiment shown in FIG. 5, the axial course 40 of the radial position of the tooth transverse of the outer toothing 16 of the flexspline 4 in the axial direction in the regions 64, 68 neighboring the constantly radially reduced region 44 is non-linear. The curve is convexly curved. A convex axial course 40 of the radial position of the tooth transverse of the outer toothing 16 of the flexspline 4 makes it possible to further reduce the local contact stresses on the tooth flank. A convex course is more difficult to manufacture.

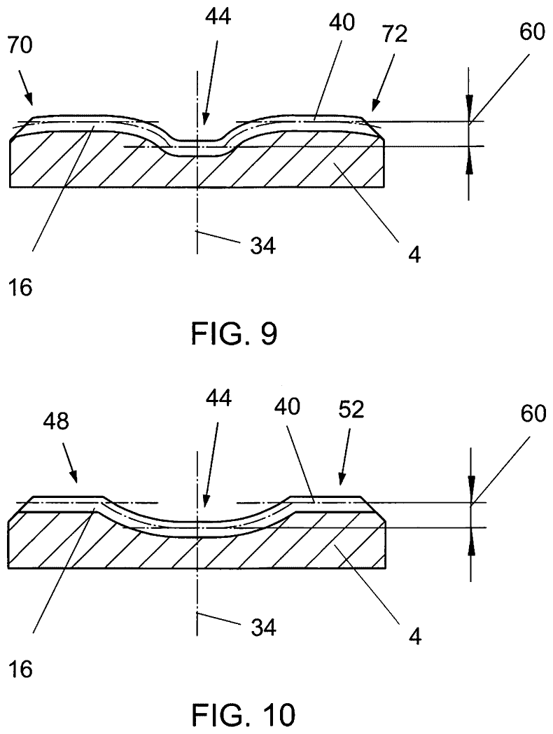

FIG. 9 shows a fifth preferred embodiment of the axial course 40 of the radial position of the tooth transverse of the outer toothing 16 of the flexspline 4. In contrast to the course shown in FIG. 8, this embodiment has additional reductions (reductions in radial expansion) on the front sides 70, 72 of the flexspline 6. These additional reduced regions can reduce increased stresses at the front-side edges of the toothings of the circular spline, dynamic spline and flexspline.

FIG. 10 shows a fifth preferred embodiment of an axial course 40 of the radial position of the tooth transverse of the outer toothing 16 of the flexspline 4. In contrast to the embodiment shown in FIG. 5, the axial course 40 of the radial position of the tooth transverse of the outer toothing 16 of the flexspline 4 is non-linear in the axial direction. The course is concavely curved in a central radially reduced region 44. A concave axial course of the radial position of the tooth transverse of the outer toothing 16 of the flexspline 4 is easier to produce, but can lead to less favorable local contact stresses on the tooth flank compared to the convex embodiment (FIG. 9).

Compared to a known axial course of the radial position of the tooth transverse of the outer toothing 16 of the flexspline 4, the load on the tooth flanks is also more favorable in this embodiment. Adjacent to the region 44, two regions 48, 52 are formed with a constant axial course of the radial tooth transverse.

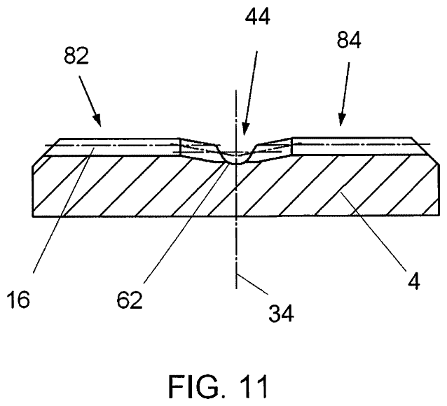

FIG. 11 shows a sixth preferred embodiment of an axial course 40 of the radial position of the tooth transverse of the outer toothing 16 of the flexspline 4. In this embodiment, the outer toothing 16 is completely interrupted in the central radially reduced region 44 by a groove 62, so that a first outer toothing 82 and a second outer toothing 84 are formed, which together form the outer toothing 16 of the flexspline 4. In a radially reduced region 44, the axial course 40 of the radial position of the tooth transverse of the outer toothing 16 of the flexspline 4 is radially reduced, formed, which is interrupted in the region of the center plane 34 by the groove 62.

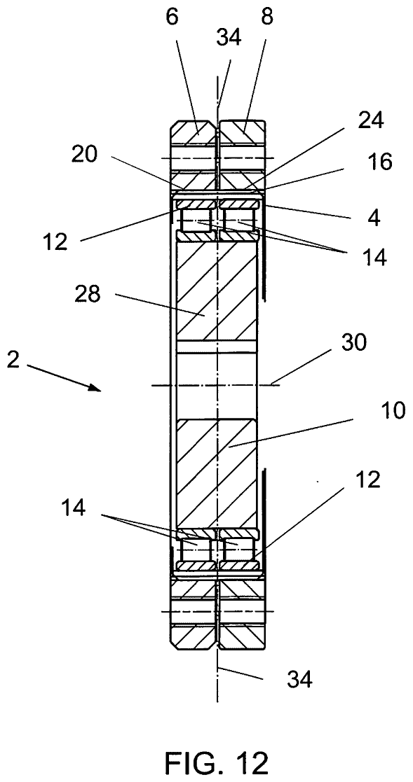

FIG. 12 shows a flat gearing 2 in a further preferred embodiment. The flat gearing 2 has two rolling bearings 12, in each of which rolling elements 14 are arranged, which in the present exemplary embodiment are designed as rollers. Rollers can bear higher loads than balls.

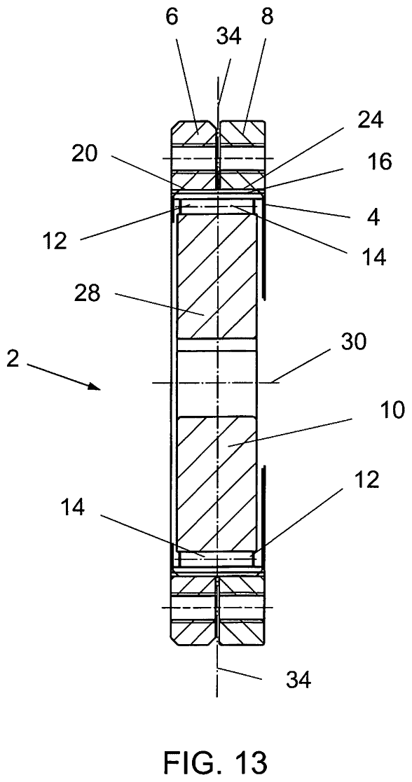

FIG. 13 shows a further flat gearing 2 in a preferred embodiment. The flat gearing according to FIG. 13 has a ball rolling bearing 12 that is shared by the circular spline 6 and dynamic spline 8, wherein the shared rolling elements 14 are designed as needle rollers.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

### LIST OF REFERENCE NUMERALS

2 Flat gearing
4 Flexspline
6 Circular spline
8 Dynamic spline
10 Wave generator
12 Rolling bearing
14 Rolling element
16 Outer toothing
20 Inner toothing
24 Inner toothing
28 Plug
30 Center axis, transmission axis
34 Plane between circular spline and dynamic spline
40 Axial course of the radial position of the tooth transverse of the outer toothing of the flexspline
44 Radially reduced region
48,52 Region at the end faces
60 Distance
62 Groove
64,68 Region
70,72 Front surface
82 First outer toothing
84 Second outer toothing

1. A flat gearing in the form of a strain wave gearing, comprising:
a circular spline having an inner toothing;
a dynamic spline which is axially adjacent to the circular spline and has an inner toothing;
a flexible flexspline which is arranged inside the circular spline and dynamic spline and has at least one outer toothing; and
a wave generator which is arranged inside the flexspline for deforming the flexspline in the radial direction, wherein an interlocking, torque-transmitting connection is established between the circular spline and the flexspline at two opposing points on the flexspline and between the flexspline and the dynamic spline at four positions on either side of the contact with the circular spline,
and wherein an axial course of the radial position of the tooth transverse of the at least one outer toothing of the flexspline has a region which is shifted radially in the direction of a center axis of the flat gearing.

2. The flat gearing according to claim 1, wherein a greatest radial shift of the radially reduced region in the direction of the center axis is located in the region of a plane between the circular spline and the dynamic spline.

3. The flat gearing according to claim 1, wherein the radially reduced region is formed symmetrically or asymmetrically with respect to a plane between the circular spline and the dynamic spline.

4. The flat gearing according to claim 1, wherein the front section of the outer toothing of the flexspline shifts in the direction of the center axis axially from the radially reduced region on both sides in the direction of the front sides in a manner that linearly radially decreases.

5. The flat gearing according to claim 1, wherein the front section of the outer toothing of the flexspline shifts in the region of one front surface or both front surfaces of the flexspline and the axial course of the radial shift assumes a constant value.

6. The flat gearing according to claim 1, wherein the axial course of the radial shift of the front section of the outer toothing of the flexspline has a convex shape in the radially reduced region.

7. The flat gearing according to claim 1, wherein the axial course of the radial shift of the front section of the outer toothing of the flexspline has a concave shape in the radially reduced region.

8. The flat gearing according to claim 1, wherein the front section of the outer toothing of the flexspline is shifted in the direction of the center axis in the region of one or both front sides of the flexspline.

9. The flat gearing according to claim 1, wherein the flexspline comprises two outer toothings which are separated from one another by a groove.

10. The flat gearing according to claim 1, further comprising a roller bearing arranged radially inside the flexspline, wherein the roller bearing has rolling elements of configured as balls.

11. The flat gearing according to claim 1, further comprising a roller bearing arranged radially inside the flexspline, wherein the roller bearing has rolling elements configured as rollers or needles.

12. A strain wave gearing, comprising:
a circular spline having an inner toothing;
a dynamic spline which is axially adjacent to the circular spline and has an inner toothing;
a flexible flexspline which is arranged inside the circular spline and dynamic spline and has at least one outer toothing; and
a wave generator which is arranged inside the flexspline for deforming the flexspline in the radial direction, wherein an interlocking, torque-transmitting connection is established between the circular spline and the flexspline at two opposing points on the flexspline and between the flexspline and the dynamic spline at four positions on either side of the contact with the circular spline, and wherein an axial course of the radial position of the tooth transverse of the at least one outer toothing of the flexspline has a region which is shifted radially in the direction of a center axis of the strain wave gearing.

13. The strain wave gearing according to claim 12, wherein a greatest radial shift of the radially reduced region in the direction of the center axis is located in the region of a plane between the circular spline and the dynamic spline.

14. The strain wave gearing according to claim 12, wherein the front section of the outer toothing of the flexspline shifts in the direction of the center axis axially from the radially reduced region on both sides in the direction of the front sides in a manner that linearly radially decreases.

15. The strain wave gearing according to claim 12, wherein the front section of the outer toothing of the flexspline shifts in the region of one front surface or both front surfaces of the flexspline and the axial course of the radial shift assumes a constant value.
